(19) United States
(12) Patent Application Publication
(10) Pub. No.: US 2002/0040916 A1
(43) Pub. Date: Apr. 11, 2002

(54) Carrying rack for vehicle

(76) Inventor: Spencer Hibbs, Terence Bay (CA)

Correspondence Address: SUGHRUE, MION, ZINN, MACPEAK & SEAS, PLLC, 2100 Pennsylvania Avenue, NW, Washington, DC, 20037-3213, US

(21) Appl. No.: 09/971,712

(22) Filed: Oct. 9, 2001

(30) Foreign Application Priority Data
Oct. 6, 2000 (CA) 2,322,357

(51) Int. Cl. B60R 7/00

(52) U.S. Cl. 224/482

(57) ABSTRACT

A carrying rack is described for use as a pair in tandem for supporting elongated loads, such as lumber and piping. The rack comprises a rigid elongated member having an upper hook portion which fits over the bottom of a vehicle window frame or the top of a side box panel of a pickup truck. A lower trailing portion of the elongated member rests against the outside of a vehicle door or the side of the truck box. An intermediate support portion extends laterally from the elongated member and has a concavely curved support area for supporting a load.

This invention relates to a carrying rack for use in pairs for supporting elongated objects on the side of a vehicle for transporting the objects.

It is well known to transport elongated objects, such as lumber, piping, ladders, skis and the like by means of a roof rack on an automobile or van, or by using the interior cabin of a vehicle or the trunk thereof, in each case with the elongated article protruding from the vehicle in a potentially dangerous manner.

A number of solutions to this type of problem have been proposed. For instance, U.S. Pat. No. 4,722,465 (Brogie) describes a carrier attachment assembly comprising a rigid base member, a rigid shelf member hingedly connected at one end to the base member, a rigid end member hingedly connected to the other end of the shelf member and an attachment member connected to the base member for attachment thereof to an automobile. This device is cumbersome to attach and use and costly to produce because of the number of parts.

U.S. Pat. No. 4,108,342 (Riva) describes a carrier holder for an automobile including a line having a closed loop portion at one end and an enlarged plug at the other end. The plug is adapted for positioning within the trunk or hood of an automobile such that the line will project outwardly through the space between the trunk or hood and the adjacent fender. A suction cup is positioned along the line and serves as a positioning element for positioning the device with respect to a fender. In use, the closed loop portion of the line extends outwardly over the fenders and serves as an attachment point for securing cargo to the automobile, two such devices normally being used in tandem for supporting a large load such as lumber. This arrangement is susceptible to the drawback of causing load chafing or rubbing against the vehicle side during a bumpy ride or while negotiating a sharp curve. The prior arrangement is furthermore complicated and not easy to install and implement, with potential tangling or snagging of the line.

Furthermore, my prior Canadian Industrial Design Registration No. 80132 illustrates a rudimentary vehicle rack having a hook portion at one end thereof, a downwardly extending portion and a lateral arm for supporting a load when used as a pair in tandem. This prior design, though an improvement over the arrangements described in the above patents, lacks some stability and versatility with respect to oversize and heavy articles.

It is an object of the present invention to provide an improved carrying rack for a vehicle which is easy to use, secure and reliable and avoids the shortcomings and disadvantages of prior arrangements.

Accordingly, the invention provides a carrying rack for an automotive vehicle, comprising:

a rigid elongated member, normally operable as a pair in tandem, said member having an upper hook portion capable of fitting over and resting on a horizontal edge of a vehicle, such as a side window or truck box panel;

a lower trailing portion adapted to rest against a side panel of a vehicle; and

an intermediate rack member protruding laterally of the elongated member and adapted to support a load.

Generally speaking, the carrying rack will be deployed as a set of two racks, i.e. a pair thereof, which may be suspended over the tops of the front and rear passenger side doors of an automobile or van with, the windows being wound fully down, the upper hook portion of each rack being supported by the top edge of the door and the lower trailing portion resting against the side of the vehicle door. As a further alternative, the pair of racks may be suspended from the top of the side panel of the box of a pickup truck. In each instance, elongated loads such as lumber, piping, rolled carpets, skis and other elongated rigid items may be suspended in a secure manner by being placed on the intermediate rack portion protruding laterally of the elongated member of the carrying rack.

The upper hook member is advantageously configured as an arched or curved structure which can accommodate a range of thicknesses of window frame or box panel. Moreover, the laterally protruding intermediate rack member is also preferably of concavely curved configuration to permit the carrying of a variety of elongated loads of different cross-sectional sizes and shapes, including squared lumber such as 2×4's, rolled carpets, cylindrical piping such as a single large diameter pipe or a plurality of small gauge piping, and somewhat more irregular shaped elongated articles, such as a pair of skis.

The carrying rack is advantageously made of plastic, preferably polypropylene, with a ribbed structure to provide reinforcement and adequate strength. In this way, the possibility of warping during use is avoided. The rack is preferably provided with a plurality of small holes to facilitate the ingress of a cord or cable for securing the load on the racks. For this purpose, holes are conveniently located either side of the intermediate rack portion, or load arm, to permit attachment to a load or the tying of a cord around a load. In addition, apertures are advantageously provided near the distal end of the upper hook portion and near the bottom of the lower trailing portion for the optional securing of the carrying racks with a cord, rope or cable to encircle inside and outside around the bottom of the vehicle side doors or, in the case of a pickup truck or van, the bottom panel or vehicle chassis.

In a preferred embodiment, a cushioned instep or gasket strip of foam rubber, rubber or other durable resilient material is disposed on the inside face of the rack which might contact a window top edge or door panel of a vehicle, so as to function as a cushioning strip to absorb shock and stress and thereby avoid damage to glass or painted surfaces.

In an alternative embodiment, the laterally protruding intermediate rack portion, or load arm, may be designed to be removable from the carrying rack so as to be interchangeable by load arms of different heights or dimensions. In this case, the elongated member of the carrying rack is provided with a pair of recesses into which projections at the interior edge of the load arm can fit in an interlocking tanner.

The carrying rack of the invention provides the user with an easy and economical alternative system for temporarily carrying and transporting elongated items in a safe manner on a wide range of vehicles, instead of buying and mounting expensive roof racks or carrying elongated items protruding through an open window at the side or rear of an automobile or station wagon with the attendant risks and potential danger to other road users.

Embodiments of the invention will now be described by way of example with reference to the accompanying drawings, in which:

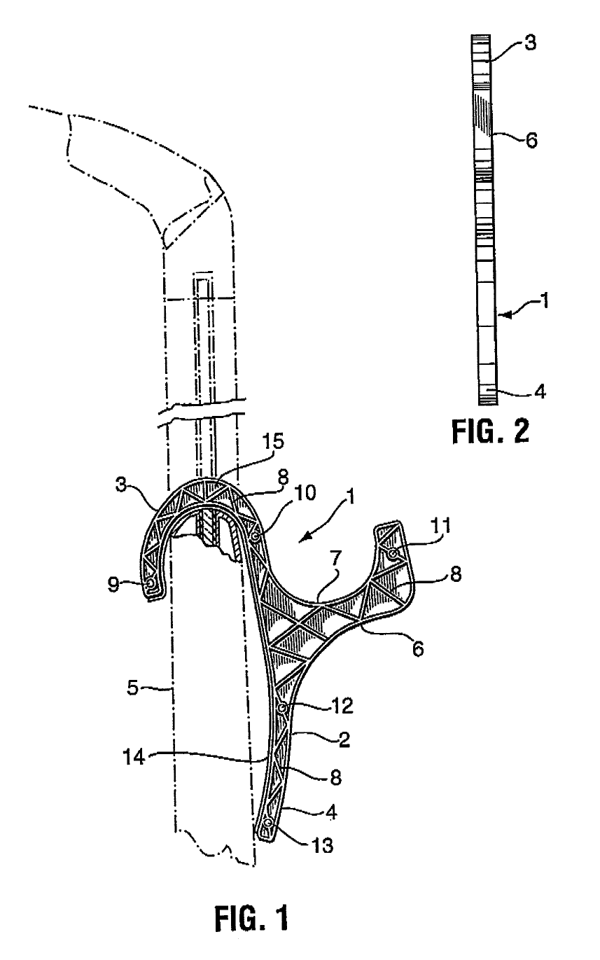

FIG. 1 is a front view of a carrying rack according to an embodiment of the invention;

FIG. 2 is a right side view of the carrying rack shown in FIG. 1;

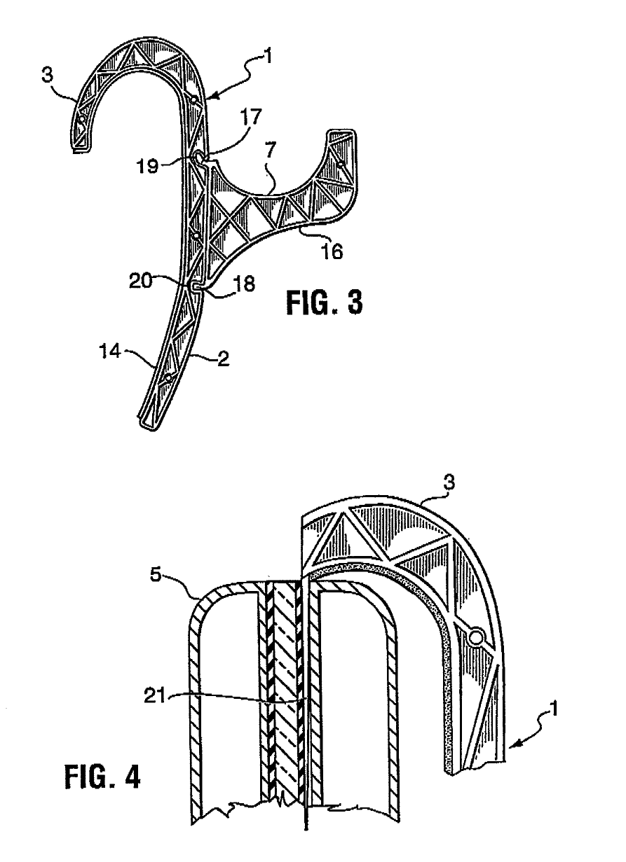

FIG. 3 in a front view of another embodiment of the carrying rack; and

FIG. 4 is a fragmentary front view of a further embodiment of the invention.

Referring now to FIG. 1, a carrying rack 1 comprises a rigid elongated member 2 having an upper hook-shaped portion 3 and a lower trailing portion 4. The hook-shaped portion 3 is adapted to hook over and be supported by a car door 5, with the trailing end 4 contacting the side of the car door. The hook-shaped portion 3 is configured as an arched or curved structure to accommodate a range of thicknesses of vehicle door. In normal use, one carrying rack is suspended from the passenger-side front door of an automobile or van and a second rack, deployed in tandem with the first rack, is suspended from the passenger-side rear door of the vehicle. Alternatively, a pair of racks can be suspended in spaced relationship from the top of a side panel of the box of a pickup truck.

The carrying rack 1 is provided at its mid section with an intermediate rack member 6 which extends laterally from the elongated member 2 and is formed with a concavely curved support section 7 which is adapted to support an end portion of any one of a variety of elongated loads of different cross-section and different shape, including squared lumber such as 2×4's or 2×6's, a rolled carpet, a large diameter cylindrical pipe or a plurality of smaller gauge piping, or a more irregular shaped elongated article, such as a pair of skis.

The carrying rack 1 is formed with reinforcement ribs 8 as a type of I-beam construction for the purpose of strengthening the carrying rack and preventing the warping or bending thereof when deployed with heavy loads. At the save time, the ribs permit production of the carrying rack with less material, while maintaining and improving the strength and warp prevention characteristics. Holes 9, 10, 11, 12 and 13 are provided at spaced locations throughout the carrying rack for the purpose of attaching a cord or cable to secure a load or the secure the carrying rack to a vehicle. The hole 9 at the end of the hook-shaped portion 3 and the hole 13 at the lower end of the trailing portion 4 facilitate securing the rack with a cord, rope or cable (not shown), which encircles the inside and outside of the side door of the vehicle to secure the rack firmly in place, if such is required. The holes 10 and 11 are primarily for insertion of a cord, rope or cable (not shown) for securing a load inside the support section 7.

A cushioned instep 14 is placed along the inside face of the carrying rack for the purpose of absorbing shock and stress and for protecting painted surfaces. This instep 14 can advantageously be formed of rubber or foam rubber or other resilient material.

The upper hook-shaped portion 3 is advantageously formed with a slightly wider central section 15 and this top arch portion permits the device to withstand the extra stress which may occur in that area with certain door and panel widths.

Turning now to FIG. 3, a modified embodiment is illustrated which includes a detachable lateral rack member 16 which is configured similarly to the concavely curved rack member 6 shown in FIG. 1. The member 16 is attachable to the elongated member 2 by means of a hinge-type mechanism 17 at an upper portion of the member 16 and a swivel locking mechanism 18 at the bottom thereof. The hinge-type mechanism 17 and the swivel locking mechanism 18 each fit within recesses 19 and 20, respectively on the elongated member 2. The rack member 16 is thus removable to facilitate storage and transport of the carrying rack 1. In addition, this arrangement permits replacing the rack member 16 by another rack member of different dimensions, for instance with a smaller or larger support section 7 or a section 7 of different cross-sectional configuration, e.g. rectangular instead of curved. Furthermore, the rack member 16 can be designed with a plurality of support sections disposed one above the other, for instance two such sections or even three such sections. This facilitates additional carrying capacity or division of heavy elongated objects into two separate portions to reduce stress at any one point.

In a further embodiment of the invention as illustrated in FIG. 4, the upper hook-shaped portion 3 terminates in a downwardly extending strip or shim 21. In this embodiment, the strip 21 would be inserted between the outside of a vehicle door 5 and the outside surface of the window glass, so that the window could be closed during deployment of the carrying rack in rainy, snowy or cold weather.

The carrying rack its advantageously made of plastic, for instance by injection moulding, preferably polypropylene which is a strong plastic which stays flexible (as opposed to brittle) in cold weather.

I claim:

1. A carrying rack for an automotive vehicle, comprising;
a rigid elongated member, normally operable as a pair in tandem, said member having an upper hook portion capable of fitting over and resting on a horizontal edge of a vehicle, such as a side window or truck box panel;
a lower trailing portion adapted to rest against a side panel of a vehicle; and
an intermediate rack member protruding laterally of the elongated member and adapted to support a load.

2. A carrying rack according to claim 1, wherein the upper hook portion is formed as a curved structure which is concavely downwardly curved to facilitate deployment over a range of different automobile window frames and truck box panels.

3. A carrying rack according to claim 2, wherein a central section of the upper hook portion is wider than the remainder thereof to afford greater strength and stress resistance.

4. A carrying rack according to claim 1, wherein the intermediate rack member comprises a concavely upwardly curved portion capable of receiving and supporting a variety of elongated members of different cross-sectional configurations and sizes.

5. A carrying rack according to claim 1, wherein the rack is made of plastic and provided with a plurality of internal reinforcing ribs.

6. A carrying rack according to claim 1, wherein the rack is provided with one or more holes to facilitate insertion of a cord, rope or cable to facilitate securing the rack to an automobile door or truck box or a panel or chassis of either thereof.

7. A carrying rack according to claim 1, wherein the rack is provided with one or more holes to facilitate insertion of a cord, rope or cable to permit securing and stabilizing an elongated load positioned in the rack member.

8. A carrying rack according to claim 1, wherein a strip or layer of resilient material is disposed on an inside face of the rack to cushion the contact of the upper hook portion and the lower trailing portion with a surface or edge of a vehicle to absorb shock and stress and avoid damage thereto.

9. A carrying rack according to claim 1, wherein the upper hook portion comprises a curved structure adjoining a downwardly extending strip or shim, the curved structure being capable of surmounting a lower side of a window frame of a vehicle, while the strip or shim is capable of extending down a gap between a window and door frame of the vehicle, so the carrying rack may be deployed during inclement weather with the window closed.

10. A carrying rack according to claim 1, wherein the intermediate rack member is detachable from and securable to the elongated member.

11. A carrying rack according to claim 10, wherein the detachable intermediate rack member is securable to the elongated member by means of a hinge type mechanism located at an upper portion of the intermediate rack member and a swivel locking mechanism located at a lower portion of the intermediate rack member, each said mechanism including a protruding element which cooperates with a receiving element of said elongated member.

12. A carrying rack according to claim 1, wherein the intermediate rack member includes a plurality of concavely upwardly curved portions, each capable of receiving one or more elongated members for the support and transportation thereof, each said curved portion being disposed in mutually spaced relationship one above another.
